(19) United States
(12) Patent Application Publication
(10) Pub. No.: US 2023/0405897 A1
(43) Pub. Date: Dec. 21, 2023

(54) MATERIAL REFLOW PREVENTING DEVICE AND A MOLDING APPARATUS WITH THE SAME

(71) Applicants: Cheng-Ho CHEN, Huatan Township (TW); Chih-Tsung KUO, Taichung City (TW)

(72) Inventors: Cheng-Ho CHEN, Huatan Township (TW); Chih-Tsung KUO, Taichung City (TW); Chuen-Cherng YANG, Taichung City (TW)

(73) Assignees: Cheng-Ho CHEN, Huatan Township (TW); Chih-Tsung KUO, Taichung City (TW)

(21) Appl. No.: 18/333,706

(22) Filed: Jun. 13, 2023

(30) Foreign Application Priority Data
Jun. 21, 2022 (TW) 111123096

(51) Int. Cl. B29C 45/58; B29C 45/74

(52) U.S. Cl. CPC B29C 45/581; B29C 45/74

(57) ABSTRACT

A molding apparatus includes a machine base, a feeding unit, a material reflow preventing device and a pair of molds. The material reflow preventing device includes a material conduit and a heating unit. The material conduit includes inlet and outlet ports at two opposite ends, inner and outer peripheral surfaces radially opposite to each other, and a low-temperature conduit section, first, second and third heating conduit sections interposed between the inlet and outlet ports. The inner peripheral surface has a spiral groove which extends from inlet port to the outlet port. The heating unit is disposed to heat the material conduit and control the different temperatures in the sections. The reflow of a fluid-state material along the spiral groove is gradually reduced and suspended and is solidified in the low-temperature conduit section.

### CROSS-REFERENCE TO RELATED APPLICATION

This application claims priority to Taiwanese Invention Application No. 111123096, filed on Jun. 21, 2022.

### FIELD

The disclosure relates to an injection molding apparatus, and more particularly to a molding apparatus with a material reflow preventing device.

### BACKGROUND

Currently, optical lens are produced by injection molding, i.e., using an injection molding machine and a molding unit, such as that disclosed in US 2013/0147077. For injection molding of an optical lens, a solid-state raw material is fed, heated until molten intermittently in batches in a heating tube, and the molten molding material is pressed by a piston or a press to be injected into a cavity of a mold through a nozzle. After the cavity is filled with the molding material, a cooling system of the molding unit is operated to cool the molding material, and the mold is opened to remove the molded product. During the injection molding process, thermal expansion of the raw material occurs when heated and molten, which results in reflow of the material and insufficient pressure for pressing the material, thereby adversely affecting the quality of the molded product.

### SUMMARY

Therefore, an object of the disclosure is to provide a material reflow preventing device for a molding apparatus that can alleviate at least one of the drawbacks of the prior art.

According to the disclosure, the material reflow preventing device is adapted for melting a solid-state linear material into a fluid-state material and injecting the fluid-state material into a molding unit. The material reflow preventing device includes a material conduit and a heating unit. The material conduit extends along a longitudinal axis, and includes an inlet port for entrance of the solid-state linear material, an outlet port opposite to the inlet port along the longitudinal axis for permitting flow of the fluid-state material out of the material conduit, an inner peripheral surface extending from the inlet port to the outlet port and surrounding the longitudinal axis to define a chamber therein, an outer peripheral surface radially opposite to the inner peripheral surface, a low-temperature conduit section adjacent to and downstream of the inlet port, a first heating conduit section interposed between the low temperature conduit section and the outlet port, a second heating conduit section interposed between the first heating conduit section and the outlet port, and a third heating conduit section interposed between the second heating conduit section and the outlet port. The inner peripheral surface has a spiral groove which extends from inlet port to the outlet port and which surrounds the longitudinal axis. The heating unit is disposed outwardly of the material conduit and along the longitudinal axis to heat the material conduit such that a material in the third heating conduit section reaches a temperature larger than that of a material in the second heating conduit section, the temperature of the material in the second heating conduit section is larger than that of a material in the first heating conduit section, and the temperature of the material in the first heating conduit section is larger than that of a material in the low-temperature conduit section.

Another object of the disclosure is to provide a molding apparatus that can alleviate at least one of the drawbacks of the prior art.

According to the disclosure, the molding apparatus includes a machine base, a feeding unit, a material reflow preventing device, an upper mold and a lower mold, and a multi-block driving device. The feeding unit is mounted on the machine base for transporting a solid-state linear material along a direction of a longitudinal axis, and includes a plurality of feeding roller assemblies which are spaced apart from each other along the longitudinal axis, and a plurality of drive motors which are disposed to respectively drive rotation of the feeding roller assemblies. The material reflow preventing device is mounted on the machine base adjacent to the feeding unit, and includes a material conduit, a ceramic outer tube, a heating unit and a solid-state linear material moving unit. The upper mold and the lower mold are disposed adjacent to the outlet port of the material reflow preventing device to receive the fluid-state material ejected from the outlet port in a closed state. The multi-block driving device is mounted on the machine base to move and lock the upper mold and the lower mold to the closed state.

With the spiral groove and the heating unit which controls the temperature in the material conduit, the reflow of the fluid-state material is gradually reduced and suspended and the reflow material is solidified in the low-temperature conduit section to stick together with the solid-state linear material so as to prevent adverse reflow.

### BRIEF DESCRIPTION OF THE DRAWINGS

Other features and advantages of the disclosure will become apparent in the following detailed description of the embodiment with reference to the accompanying drawings. It is noted that various features may not be drawn to scale.

FIG. 1 is a schematic view illustrating an embodiment of a molding apparatus according to the disclosure.

FIG. 2 is a fragmentary, partly-sectional schematic view illustrating a material reflow preventing device of the embodiment.

FIG. 3 is a sectional view taken along line III-Ill of FIG. 1.

FIG. 4 is an enlarged view of a part of FIG. 3.

FIG. 5 is an enlarged view of a part of FIG. 4.

FIG. 6 is a perspective view of a portion of the embodiment.

FIG. 7 is an exploded perspective view of a portion of the embodiment.

FIG. 8 is an exploded perspective view of an axial sleeve and a resilient tightening collar of the embodiment.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

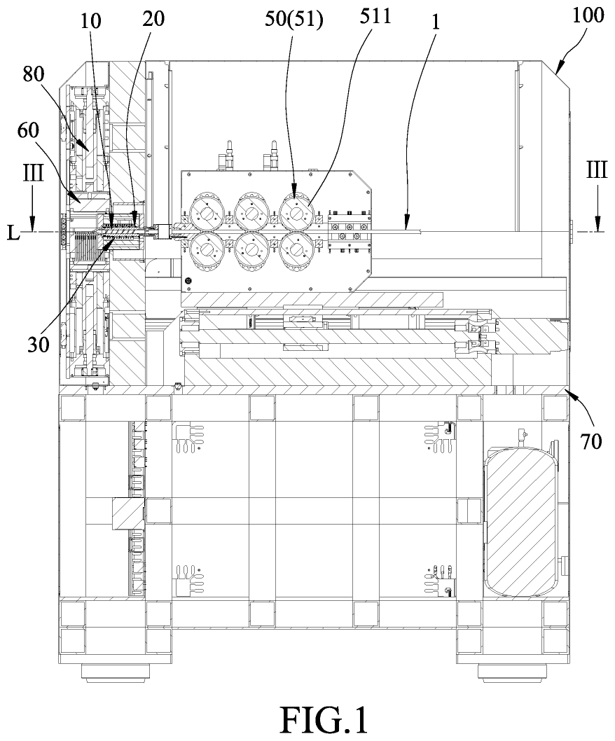

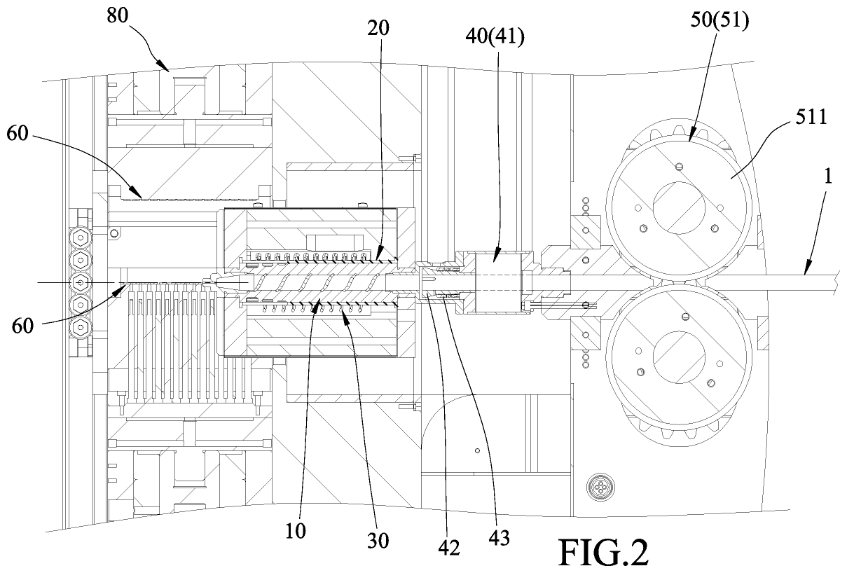

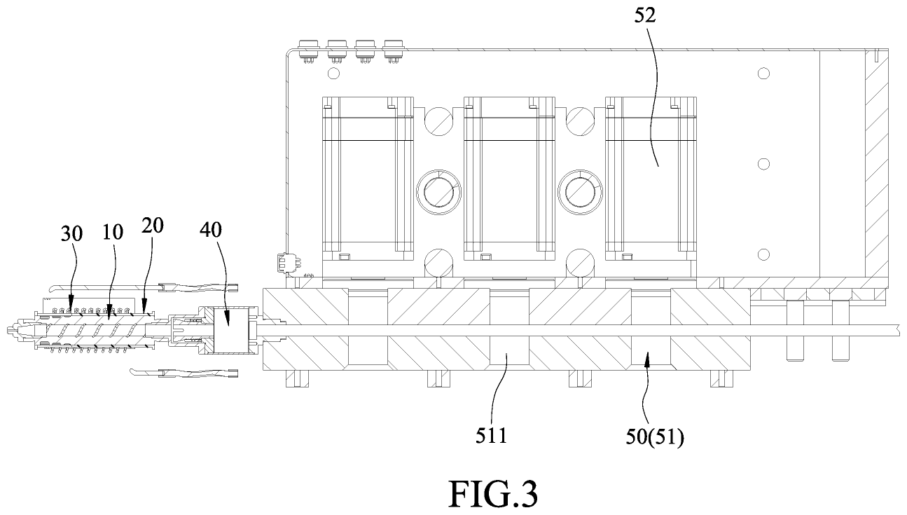

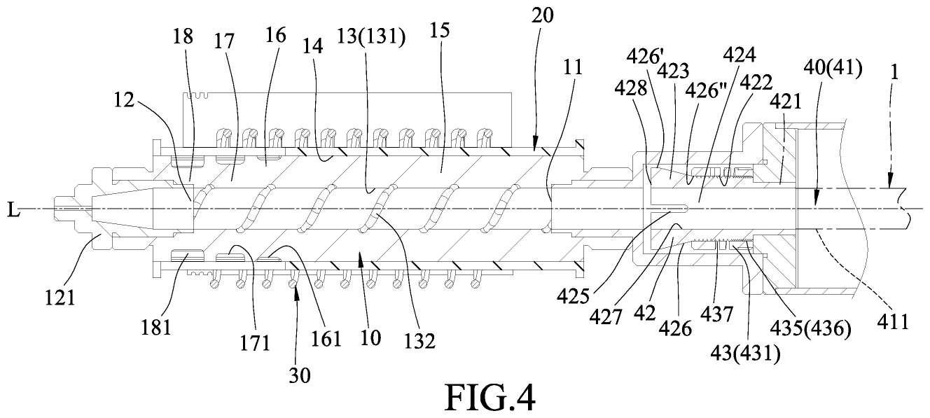

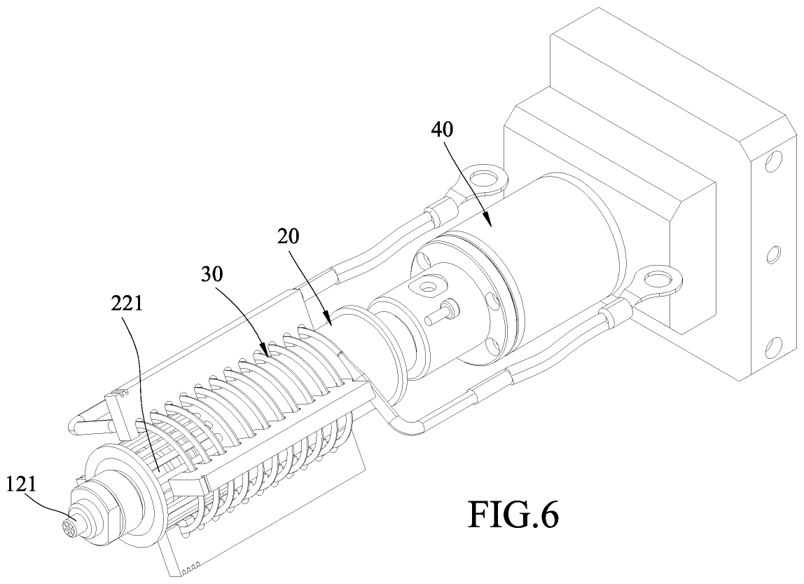

Referring to FIGS. 1 to 6, an embodiment of a material reflow preventing device according to the disclosure is adapted for heating and melting a solid-state linear material 1 into a fluid-state material and injecting the fluid-state material into a molding unit. The material reflow preventing device includes a material conduit 10, a ceramic outer tube 20, a heating unit 30 and a solid-state linear material moving unit 40. The material reflow preventing device is mounted within a molding apparatus 100. The molding apparatus 100 further includes a machine base 70, a feeding unit 50, a multi-block driving device 80 and the molding unit. The molding unit includes an upper mold and a lower mold 60. The material reflow preventing device is mounted on the machine base 70.

The material conduit 10 extends along a longitudinal axis (L), and includes an inlet port 11 for entrance of the solid-state linear material 1, an outlet port 12 opposite to the inlet port 11 along the longitudinal axis (L) for permitting flow of the fluid-state material out of the material conduit 10, an inner peripheral surface 13 which extends from the inlet port 11 to the outlet port 12 and which surrounds the longitudinal axis (L) to define a chamber 131 therein, an outer peripheral surface 14 radially opposite to the inner peripheral surface 13, a low-temperature conduit section 15 adjacent to and downstream of the inlet port 11, a first heating conduit section 16 which is interposed between the low-temperature conduit section 15 and the outlet port 12, a second heating conduit section 17 which is interposed between the first heating conduit section 16 and the outlet port 12, and a third heating conduit section 18 which is interposed between the second heating conduit section 17 and the outlet port 12. Additionally, a nozzle 121 is disposed at the outlet port 12.

The inner peripheral surface 13 has a spiral groove 132 which extends from inlet port 11 to the outlet port 12 and which surrounds the longitudinal axis (L). The spiral groove 132 is in communication with the chamber 131.

Specifically, the material conduit 10 has a first annular slot 161 which is formed at the first heating conduit section 16 and recessed from the outer peripheral surface 14 by a first depth to terminate at a first slot base wall 162, a second annular slot 171 which is formed at the second heating conduit section 17 and recessed from the outer peripheral surface 14 by a second depth to terminate at a second slot base wall 172, and a third annular slot 181 which is formed at the third heating conduit section 18 and recessed from the outer peripheral surface 14 by a third depth. The second depth of the second annular slot 171 is larger than the first depth of the first annular slot 161, and smaller than the third depth of the third annular slot 181. That is, a second thickness (t2) defined between the second slot base wall 172 and the inner peripheral surface 13 is smaller than a first thickness (t1) defined between the first slot base wall 162 and the inner peripheral surface 13, and larger than a third thickness (t3) defined between the third slot base wall 182 and the inner peripheral surface 13.

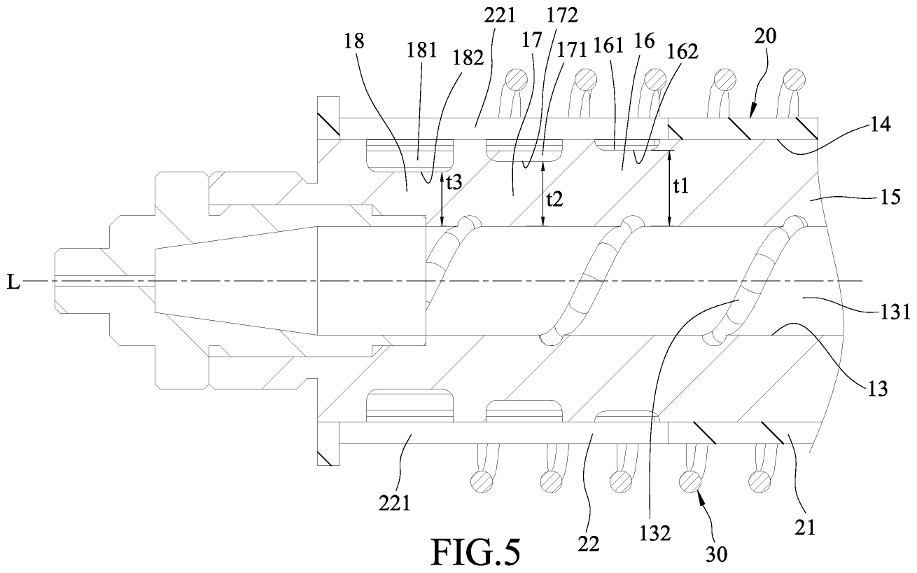

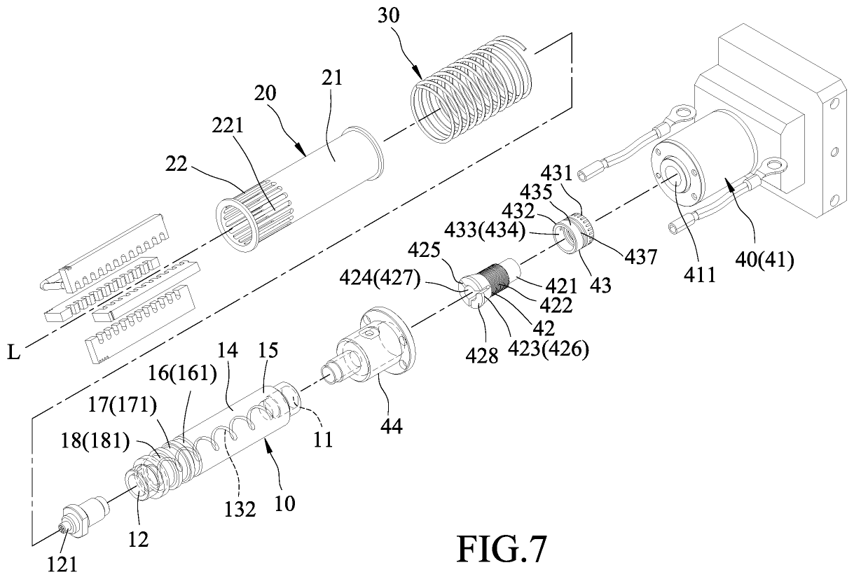

The ceramic outer tube 20 is sleeved on the material conduit 10 and is coaxially interposed between the material conduit 10 and the heating unit 30. With reference to FIGS. 5 and 7, the ceramic outer tube 20 has a solid section 21 and a hole forming section 22 opposite to the solid section 21 along the longitudinal axis (L). The hole forming section 22 has a plurality of radial holes 221, each extending axially parallel to the longitudinal axis (L). The solid section 21 extends to correspond at the low-temperature conduit section 15. The radial holes 221 have an opening that extends from the first heating conduit section 16 to the third heating conduit section 18. That is, the radial holes 221 are spaced apart from the low-temperature conduit section 15 in a direction of the longitudinal axis (L) to not reach the low-temperature conduit section 15.

The heating unit 30 is disposed outwardly of the material conduit 10 and the ceramic outer tube 20 and along the longitudinal axis (L) to heat the material conduit 10. In this embodiment, the heating unit 30 is in the form of a spiral tubular electric heater to heat the material conduit 10 through the radial holes 221. With the smallest thickness (t3) between the third slot base wall 182 and the inner peripheral surface 13, a material in the third heating conduit section 18 reaches a largest heating temperature, which is larger than that of a material in the second heating conduit section 17, and a material in the first heating conduit section 16 reaches a smallest heating temperature, which is larger than that of a material in the low-temperature conduit section 15. Thus, the heating temperature in the third heating conduit section 18 is larger than that in the second heating conduit section 17. The heating temperature in the second heating conduit section 17 is larger than that in the first heating conduit section. The heating temperature in the first heating conduit section 16 is larger than the temperature in the low-temperature conduit section 15.

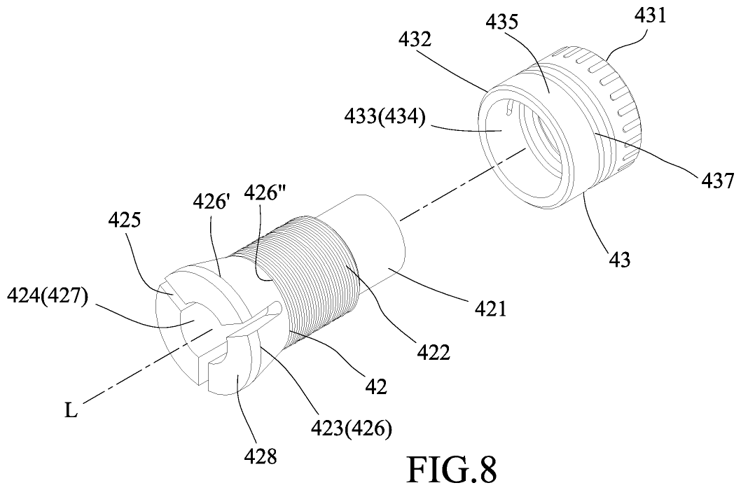

With reference to FIGS. 7 and 8, the solid-state linear material moving unit 40 is disposed upstream of the inlet port 11, and includes an axially rotating piece 41, an axial sleeve 42 which is connected and rotatable with the axially rotating piece 41, a resilient tightening collar 43 which is sleeved on the axial sleeve 42, and an insulation connecting piece 44 which is connected between the axially rotating piece 41 and the material conduit 10.

The axially rotating piece 41 has an axial hole 411 for passing the solid-state linear material 1 therethrough and for spirally feeding the solid-state linear material 1 when rotating. The axial sleeve 42 is tubular to define a tubular hole 424 which extends along the longitudinal axis (L), and is disposed adjacent to the inlet port 11 of the material conduit 10 to communicate the axial hole 411 with the inlet port 11. Specifically, the axial sleeve 42 has a connecting end portion 421 which is coaxially connected with the axially rotating piece 41, a flared end portion 423 which is opposite to the connecting end portion 421 and which widens along the longitudinal axis (L) to terminate at an end wall 428, and an externally threaded portion 422 which is interposed between the connecting end portion 421 and the flared end portion 423. The flared end portion 423 has an outer flared surface 426 and an inner surrounding surface 427 radially opposite to the outer flared surface 426. The outer flared surface 426 has a larger-diameter section 426′ extending from the end wall 428, and a smaller-diameter section 426″ extending from the larger-diameter section 426′ in the direction of the longitudinal axis (L). A plurality of splits 425 are formed in the flared end portion 423, and are angularly spaced apart from each other. Each split 425 extends from the end wall 428 in the direction of the longitudinal axis (L) and radially to the outer flared surface 426 and the inner surrounding surface 427.

The resilient tightening collar 43 is cylindrical and has an inner cylindrical surface 434 which surrounds the longitudinal axis (L) to define a circular hole 433, and an outer cylindrical surface 435 radially opposite to the inner cylindrical surface 434.

Specifically, the resilient tightening collar 43 has a fixed end 431 which is fixed on the connecting end portion 421, a movable end 432 which is opposite to the fixed end along the longitudinal axis (L) and which is movably sleeved on the flared end portion 423, an internally threaded portion 436 which is threadedly engaged with the externally threaded portion 422, and a spiral slot 437 which extends radially through the resilient tightening collar 43 and spirally around the longitudinal axis (L). The spiral slot 437 is formed between the fixed end 431 and the movable end 432. With the spiral slot 437, the movable end 432 is resiliently movable along the longitudinal axis (L) relative to the fixed end 431 to provide a biasing force toward the outer flared surface 426 for tightening the flared end portion 423.

The feeding unit 50 of the molding apparatus 100 is mounted on the machine base 70 at the other side of the solid-state linear material moving unit 40 opposite to the material conduit 20 for transporting a solid-state linear material 1 along the direction of a longitudinal axis (L). The feeding unit 50 includes a plurality of feeding roller assemblies 51 which are spaced apart from each other along the longitudinal axis (L), and a plurality of drive motors 52 which are disposed to respectively drive rotation of the feeding roller assemblies 51. Each feeding roller assembly 51 includes two feeding rollers 511 at two sides of the longitudinal axis (L) to cooperatively define therebetween a feeding path along the longitudinal axis (L) for transmitting the solid-state linear material 1 toward the chamber 131 of the material conduit 10.

The multi-block driving device 80 is mounted on the machine base 70 and is adjacent to the outlet port 12 of the material reflow preventing device. Since the structure and operation of the multi-block driving device 80 may be of a well known type, a detailed description on it will not be provided herein.

The upper mold 60 and a lower mold 60 are mounted on the machine base 70 and at a side of the outlet port 12 of the material reflow preventing device to receive the fluid-state material ejected from the outlet port 12 in a closed state. The upper and lower molds 60 are driven by the multi-block driving device 80 so as to be moved and locked to the closed state.

Referring to FIGS. 1 to 4, in operation, through the drive motors 52, the feeding rollers 51 make a rolling movement to transmit the solid-state linear material 1 toward the solid-state linear material moving unit 40 and the material conduit 10. The solid-state linear material 1 passes through the axial hole 411 of the axially rotating piece 41 by means of rotation of the axially rotating piece 41, and the axial sleeve 42 and the resilient tightening collar 43 are rotated with the axially rotating piece 41. With the spiral slot 437 of the resilient tightening collar 43 and the splits 425 of the axial sleeve 42, the flared end portion 423 is narrowed and tightened by the resilient tightening collar 43 to radially tighten the solid-state linear material 1 in the axial sleeve 42 with a tightening force. While the feeding force that presses the solid-state linear material 1 by the feeding unit 50 is relatively large compared to the tightening force of the flared end portion 423 to keep moving of the solid-state linear material 1, a counteracting action is generated to spread out the flared end portion 423 so as to bias the movable end 432 toward the fixed end 431 to narrow the spiral slot 437 and generate a return biasing force. The movable end 432 is then immediately moved toward the flared end portion 423 to tighten the flared end portion 423 such that the resilient tightening collar 43 tightens intermittently the outer flared surface 426 to induce a spiral forward movement of the solid-state linear material 1 by the axial sleeve 42.

Subsequently, the solid-state linear material 1 enters the chamber 131 of the material conduit 10, is heated by the heating unit 30, and the part of the solid-state linear material 1 at the low-temperature conduit section 15 begins to become molten. Along with the forward movement of the solid-state linear material 1 toward the outlet port 12, the part of the solid-state linear material 1 at the third heating conduit section 18 is molten into a fluid-state material. The fluid-state material is ejected from the nozzle 121 at the outlet port 12 into the molding unit. Meanwhile, the fluid-state material in the third heating conduit section 18 reflow due to thermal expansion along the spiral groove 132 toward the second heating conduit section 18, the first heating conduit section 17 and the low-temperature conduit section 15. Thus, with the heating unit 30 which controls the temperature in the third heating conduit section 18 to be larger than that in the second heating conduit section 17, the temperature in the second heating conduit section 17 controlled to be larger than that in the first heating conduit section 16, and the temperature in the first heating conduit section 16 controlled to be larger than that in the low-temperature conduit section 15, the reflow of the fluid-state material is gradually reduced and suspended, and the reflow material is solidified in the low-temperature conduit section 15 and enters the inlet port 11 to stick together with the solid-state linear material 1 moving into the inlet port 11. In this manner, the pressure for pressing the material to the molding unit will be sufficient and maintained to improve the molded products.

As illustrated, the material reflow preventing device and the molding apparatus have a simple construction and can solve problems generated as a result of material reflow to improve the molded products.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A material reflow preventing device for melting a solid-state linear material into a fluid-state material and injecting the fluid-state material into a molding unit, said material reflow preventing device comprising:
a material conduit extending along a longitudinal axis, and including an inlet port for entrance of the solid-state linear material, an outlet port opposite to said inlet port along the longitudinal axis for permitting flow of the fluid-state material out of said material conduit, an inner peripheral surface extending from said inlet port to said outlet port and surrounding the longitudinal axis to define a chamber therein, an outer peripheral surface radially opposite to said inner peripheral surface, a low-temperature conduit section adjacent to and downstream of said inlet port, a first heating conduit section interposed between said low temperature conduit section and said outlet port, a second heating conduit section interposed between said first heating conduit section and said outlet port, and a third heating conduit section interposed between said second heating conduit section and said outlet port, said inner peripheral surface having a spiral groove which extends from said inlet port to said outlet port and which surrounds the longitudinal axis; and
a heating unit disposed outwardly of said material conduit and along the longitudinal axis to heat said material conduit such that a material in said third heating conduit section reaches a temperature larger than that of a material in said second heating conduit section, the temperature of the material in said second heating conduit section is larger than that of a material in said first heating conduit section, and the temperature of the material in said first heating conduit section is larger than that of a material in said low-temperature conduit section.

2. The material reflow preventing device of claim 1, further comprising a ceramic outer tube which is coaxially interposed between said material conduit and said heating unit, said ceramic outer tube having a plurality of radial holes, each having an opening extending axially from said first heating conduit section to said third heating conduit section.

3. The material reflow preventing device of claim 2, wherein said material conduit has a first annular slot formed at said first heating conduit section and recessed from said outer peripheral surface by a first depth to terminate at a first slot base wall, a second annular slot formed at said second heating conduit section and recessed from said outer peripheral surface by a second depth to terminate at a second slot base wall, and a third annular slot formed at said third heating conduit section and recessed from said outer peripheral surface by a third depth, wherein said second depth is larger than said first depth and smaller than said third depth, and a second thickness defined between said second slot base wall and said inner peripheral surface is smaller than a first thickness defined between said first slot base wall and said inner peripheral surface, and larger than a third thickness defined between said third slot base wall and said inner peripheral surface, said heating unit being in form of a spiral tubular electric heater.

4. The material reflow preventing device of claim 3, wherein said radial holes are spaced apart from said low-temperature conduit section in a direction of the longitudinal axis to not reach said low-temperature conduit section.

5. The material reflow preventing device of claim 4, further comprising a solid-state linear material moving unit disposed upstream of said inlet port, said solid-state linear material moving unit including an axially rotating piece, an axial sleeve which is connected and rotatable with said axially rotating piece, and a resilient tightening collar which is sleeved on said axial sleeve, said axially rotating piece having an axial hole for passing the solid-state linear material therethrough and for spirally feeding the solid-state linear material when rotating, said axial sleeve being tubular to define a tubular hole which extends along the longitudinal axis, and being disposed adjacent to said inlet port of said material conduit to communicate said axial hole with said inlet port, said axial sleeve having a connecting end portion which is connected with said axially rotating piece, a flared end portion which is opposite to said connecting end portion and which widens along the longitudinal axis to terminate at an end wall, and a plurality of splits which are formed in said flared end portion, which are angularly spaced apart from each other, and which extend from said end wall in the direction of the longitudinal axis, said resilient tightening collar having a fixed end which is fixed on said connecting end portion, a movable end which is opposite to said fixed end along the longitudinal axis and which is movably sleeved on said flared end portion, and a spiral slot which extends radially through said resilient tightening collar and spirally around the longitudinal axis such that said movable end is resiliently movable along the longitudinal axis relative to said fixed end to tighten said flared end portion.

6. A molding apparatus comprising:
a machine base;
a feeding unit mounted on said machine base for transporting a solid-state linear material along a direction of a longitudinal axis, and including a plurality of feeding roller assemblies which are spaced apart from each other along the longitudinal axis, and a plurality of drive motors which are disposed to respectively drive rotation of said feeding roller assemblies;
a material reflow preventing device mounted on said machine base adjacent to said feeding unit, and including a material conduit, a heating unit, a ceramic outer tube and a solid-state linear material moving unit;
an upper mold and a lower mold disposed adjacent to said outlet port of said material reflow preventing device to receive the fluid-state material ejected from said outlet port in a closed state; and
a multi-block driving device mounted on said machine base to move and lock said upper mold and said lower mold to the closed state.
